(19) United States
(12) Patent Application Publication
(10) Pub. No.: US 2022/0095676 A1
(43) Pub. Date: Mar. 31, 2022

(54) THERMAL DESORPTION CLEANABLE SMOKING PIPE

(71) Applicant: Matt Simkins, Redwood City, CA (US)

(72) Inventor: Matt Simkins, Redwood City, CA (US)

(21) Appl. No.: 17/035,030

(22) Filed: Sep. 28, 2020

(51) Int. Cl. A24F 1/32; A24F 5/08; B08B 7/00

(52) U.S. Cl. CPC A24F 1/32; B08B 7/0071; A24F 5/08

(57) ABSTRACT

This invention pertains to a material composition and configuration of a smoking pipe that facilitates more thorough cleaning by means of thermal desorption. Additionally, the invention describes bowl geometry that simplifies the installation of replaceable smoking pipe screens. The ridge helps position and shape the screen during installation for complicated or unintuitive bowl shapes and screen orientations.

### CROSS REFERENCE TO RELATED APPLICATION

This application claims priority over U.S. Pat. No. 4,020,853A, entitled “Smoking pipe”, filed on Oct. 2, 1975.

### FIELD OF INVENTION

The present invention relates to smoking pipes generally, to include pipes that utilize liquids for the purposes of cooling or flavor. Particularly, the invention relates to pipes that are reusable and that require occasional cleaning. This invention also pertains to a pipes that utilize a screen for filtering ashes, embers, and unburned materials.

### BACKGROUND

Pipe smoking is a popular and convenient means to ingest combustible organic material. However, one disadvantage of pipes is that they are quickly soiled by smoke deposits. Often, a mechanical utensil, such as a scraping tool, pipe cleaner, or cloth, suffice for clearing. Even so, pipe cleaning is tedious. Pipe contamination is often sticky, and water insoluble. Pipe cleaning may stain hands and clothes with unsightly, fetid tar. If the interior surfaces of the pipe are inaccessible with a utensil, soaking or boiling the pipe in a chemical solution is also a common cleaning technique. However, use of chemical solvents is generally undesirable because chemical residues may spoil the smoke when the pipe is reused. Moreover, cleaning methods used in prior art typically fail to remove all smoke contamination so that the pipe remains partially soiled even after cleaning.

Partial soiling of a pipe after cleaning has several disadvantages. First, partially soiled pipes have an undesirable appearance. Second, pipes may have pathogens on their surface which are not entirely removed. Thus, conventional cleaning methods are only marginally sanitary. Third, and perhaps most importantly, residual smoke deposits tend to taint the smoke flavor in an undesirable way when the pipe is reused.

Thermal desorption is often associated with decontamination of polluted soil from environmentally compromised sites. Thermal desorption works by vaporizing volatile organic compounds using elevated temperatures. However, the temperatures are not so high that they vaporize or damage the underlying material being cleaned. Heating soil to 500° F. is often considered sufficient to remove most volatile contamination. At a sufficiently high temperature (approximately 1,000° F.), even semi-volatile contamination is vaporized. After applying this treatment, soil becomes sterile, and often cleansed of contamination. If used on smoking pipes, thermal desorption may provide more thorough, and sterile cleaning. Additionally, thermal desorption is a potentially faster, tidier, and less labor intensive than scraping, scrubbing, or soaking.

In principal, pipe smokers have several readily available thermal desorption options available at the home or outdoors. Commercially available propane torches achieves temperatures of approximately 3,450° F. Thus, application of a torch flame to the pipe may suffice for cleaning by thermal desorption. Burning methane reaches approximately 3,550° F. Thus, holding the pipe over an open range gas stove might suffice. The primary reason why such methods are not used for pipe cleaning is because temperatures in excess of 1,000° F. tend to damage or destroy pipe materials used in prior art. Materials such as wood, metal, or polymers tend to burn, oxidize, change phase, tarnish, or melt. Other materials, such as higher temperature metals, borosilicate glasses, earthenware ceramics, or porcelain, are better able to tolerate high temperatures. However, the later class of materials tends to fracture or warp from heat gradients. Heat gradients are difficult to avoid and are caused by unequally applied heat. Moreover, fracture or warping also becomes likely when the latter materials are rapidly cooled.

Occasionally, fragments of combustible material, or even still burning material, enter the stem airway of a smoking pipe, and are subsequently inhaled by the smoker in an undesirable way. One countermeasure used in prior art is to interpose a metal screen between the combustible material and the pipe draught hole. This ensures that only smoke, or very small particles, may enter the pipe stem airway. Like the interior of the pipe body, screens becomes soiled by smoke deposits. Sometimes screens are removed and cleaned, but often they are replaced with a new screen. For convenience, screens are standardly available as circular discs in a variety of standard sizes. Accordingly, pipes that utilize screens in prior art have circular bowl airways so that the screen fits properly within the bowl. Screens are typically made from a ductile material, such as brass or stainless steel. During installation, the screen is pushed into the bowl such that the screen deforms against the interior wall of the bowl. In this way the screen mechanically yields to a circular, concave shape at the bottom of the pipe bowl.

Improper screen installation is undesirable. In order to utilize a substantial volume available for combustible material within the pipe bowl the screen must be pushed far enough into the bowl airway. However, pushing the screen too far into the bowl airway may diminish the screen's surface area available for filtering. More specifically, if the screen is pushed flush against the pipe draught hole then smoke will only pass through a small portion of the screen, thus restricting airflow and diminishing the screen's usable life. If the screen is pushed into the bowl and past the draught hole, or if it only makes partial contact with the walls of the bowl airway, debris may bypass the screen, thus defeating the screen's purpose. In prior art, the bowl and screen are both circular in shape so that the proper depth and orientation of the screen is more easily accomplished. If the bowl is non-circular, or if the pipe body is designed to accept the screen at an angle, misalignment or disorientation of the screen during installation becomes likely. Thus, pipes that utilize a screen in prior art are constrained to a circular-shape along the bowl interior with the screen being oriented concentrically within the bowl.

### SUMMARY OF THE INVENTION

In the present invention the pipe body material and bowl geometry has several improvements. The smoking pipe of the present invention withstands thermal desorption temperatures that would otherwise damage or destroy smoking pipes from prior art. There exist high melting point, low volatility materials with excellent thermal shock resistance. These materials can withstand cleaning by thermal desorption. Fine ceramics (also termed “engineering ceramics,” “industrial ceramics,” or “advanced ceramics”) is one such class of materials. The first improvement of the current invention is to compose the entire pipe body of a single piece, with a single wall, of fine ceramic so that the pipe body can withstand and facilitate thermal desorption cleaning.

A second improvement pertains to a non-circular, protruding edge along the interior airway surface of the pipe bowl. The protruding edge helps to properly position a screen as it is installed into a pipe bowl. This protruding edge is particularly useful for pipe bowls that are non-circular in shape, or that require an angled screen orientation.

### BRIEF DESCRIPTION OF THE FIGURES

FIG. 1 is a representative perspective view of the one piece smoking pipe body of the present invention which is soiled from smoking.

FIG. 2 is a representative perspective view of the smoking pipe of the present invention with a partial view of a blowtorch applying heat.

FIG. 3 depicts the method for cleaning the smoking pipe of the present invention by thermal desorption.

FIG. 4 is a top plan view of the smoking pipe of the present invention.

FIG. 5 is a representative perspective view of a screen example from prior art that was modified by plastically deformation into a shape that appropriately interfaces with the smoking pipe of the present invention.

FIG. 6 is representative cutaway view of the smoking pipe of the present invention with a modified screen being removed from the bowl.

FIG. 7 is representative cutaway view of the smoking pipe of the present invention with a modified screen removed from the bowl at a tilted angle relative to the bowl.

### DETAILED DESCRIPTION

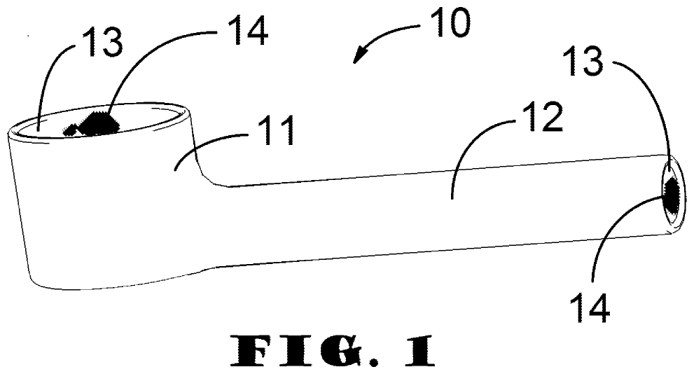

FIG. 1 depicts a preferred embodiment of a smoking pipe of the current invention. Pipe body 10 is defined as having a bowl 11 and a stem 12. The airway 13 of bowl 11 and stem 12 is depicted as having contamination 14 deposits from smoking the pipe. The pipe may have a different shape, or additional orifices for controlling airflow, and the pipe depicted in FIG. 1 is not limiting to the current invention. Pipe body 10 is composed of fine ceramic. Examples of fine ceramics would include, but are not limited to zirconium oxide, silicon nitride, aluminum oxide, their associated cermets, and mixtures thereof.

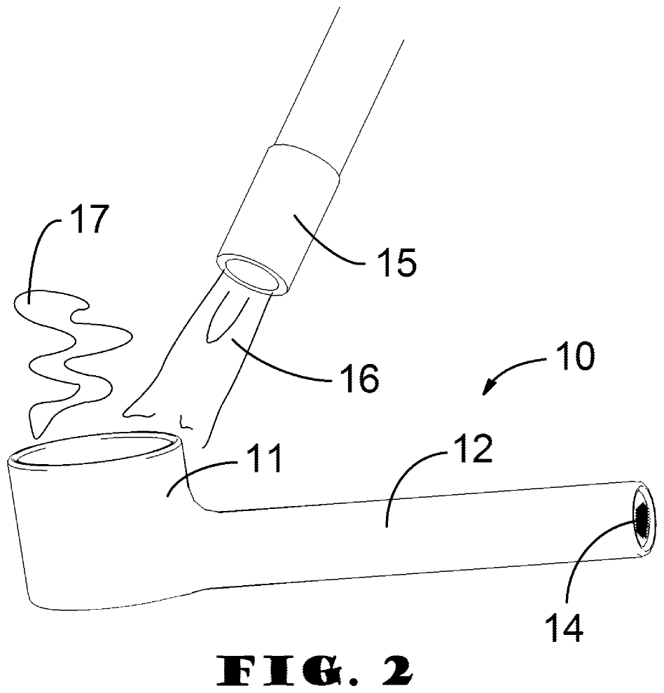

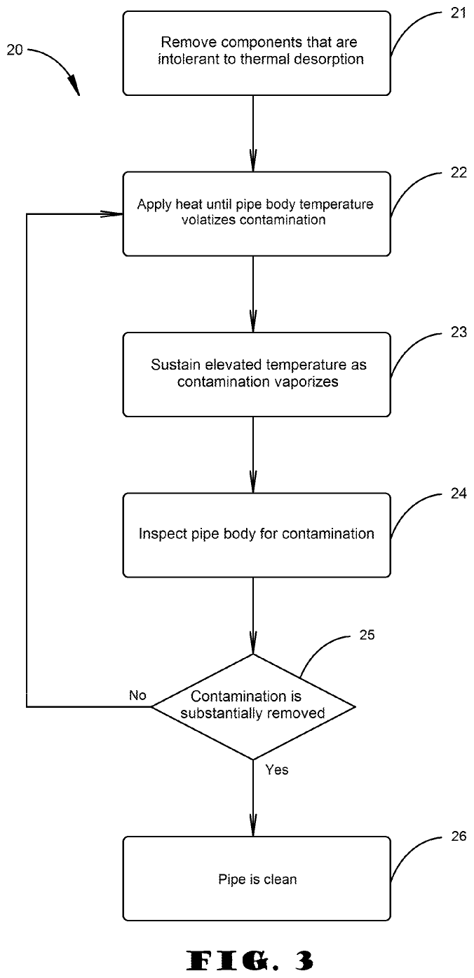

FIG. 2 depicts cleaning of pipe body 10 using thermal desorption by means of a blowtorch. Thermal desorption method 20 is depicted in FIG. 3. At step 21 all components, if any, that are possibly damaged by thermal desorption are removed. Such components may include, but are not limited to an outer encasement, cap, screen, tool accessories, or a polymeric mouthpiece. At step 22 blowtorch 15 applies flame 16 to bowl 11. Equivalently, heat sources other than a blowtorch may suffice to heat body 10. These may include, but are not limited to an open range oven, open pit fire, wood burning stove, or high temperature furnace. In step 23 heat is applied to pipe body 10 for enough duration that contamination 14 begins to vaporize. Accordingly, contamination 14 located on airway 13 of bowl 11 in FIG. 1 is converted to vapor 17, see FIG. 2. Step 23 may involve heating of portions of pipe body 10 separately, heating of the entire pipe body 10 simultaneously, or may involve heat cycles. Steps 22 and 23 may utilize higher or lower temperatures with shorter or longer durations of heat exposure respectively. After airway 13 is cleaned in the vicinity of bowl 11 in FIG. 2 the torch may then be applied to stem 12 (not pictured) in order to remove remaining contamination 14 from airway 13. In step 24 the pipe is inspected for cleanliness. For the case where portions of the pipe are manually exposed to heat, such as with a blow torch or open range oven, the pipe must cool for safe handling during inspection or subsequent cleaning. In the interests of time, it is therefore desirable that pipe body 10 can withstand rapid cooling (such as water quenching) between steps 23 and 24. At decision point 25, step 22 is either repeated if contamination 14 is still present, or the pipe is considered cleaned at step 26.

Fine ceramic has several unique materials properties that are well-suited for cleaning by thermal desorption. The cleaning method depicted in FIG. 2 exemplifies these benefits. The high melting point and chemical inertness of fine ceramics means that the pipe will not melt or burn at high temperatures that are achievable with readily available household items. Zirconium oxide (Zirconia) has a melting point of 4,920° F., silicon nitride is 6,250° F., and aluminum oxide (Alumina) is 6,800° F. By way of comparison, the melting point of brass and borosilicate glass (common pipe material used in prior art) is only 1,690° F. and 3,000° F. respectively. Thus heat sources, such as a torch or gas open range oven, can melt a common metal or glass pipe used in prior art, but is unable to melt a fine ceramic pipe.

In addition to high melting point, fine ceramics also have low coefficients of thermal expansion. FIG. 2 shows flame 16 heating bowl 11, but not stem 12. This would create a heat gradient across pipe body 10. Due to the low thermal expansion of fine ceramic, pipe body 10 will resists fracture or warping. Furthermore, even while bowl 11 in FIG. 2 is scalding hot, stem 12 is potentially safe to grasp, thus making the pipe easier to handle during cleaning. In the interests of removing the remaining contamination 14 from stem 12 after bowl 11 is considered clean, bowl 11 must first cool to allow for safe handling. To clean the pipe in a timely manner, bowl 11 must first be rapidly cooled. Blowing of cool air on the pipe, or quenching it in water are two possible approaches for rapid cooling. Fine ceramics are highly resistant to thermal shock, thus resisting fracture or warping during rapid cooling.

In the current invention pipe body 10 is constructed from a single-walled, continuous piece of fine ceramic. A single-walled pipe allows for more efficient heat transfer from the exterior of pipe body 10 to airway 13. Referring to FIG. 2, a significant proportion of contamination 14 will become deposited in airway 13 at locations that are inaccessible to direct application of flame 16. A single walled construction provides a thermal path of lower resistance than does a multi-walled pipe body. Thus, the single-wall structure allows for cleaning of inaccessible airway locations by applying flame 16, or some other heat source to the exterior of pipe body 10.

Many pipes from prior art are constructed from a plurality of component pieces. Notwithstanding, ceramic pipe components could be formed separately, and then assembled. For example, the bowl, elbow, and stem are potentially made separately and then combined to produce a complete pipe body. Of course, some means is required to join these pieces. Permanent bonds, such as metal solder or adhesive, are likely damaged during thermal desorption due to melting or burning respectively. Mechanical joints, such a threads or press fits, may contain contamination. During thermal desorption volatile contamination between mating parts may vaporize, build pressure, and rupture the pipe. Moreover, stresses may develop between materials with unequal thermal expansion rates, thereby leading to cracks or leaks. Therefore, the pipe of the current invention is composed of a single, continuous piece of fine ceramic to avoid failure during thermal desorption.

It is also possible that the fine ceramic pipe body is joined to auxiliary, non-ceramic pipe body pieces. Auxiliary components might attach to pipe body 10. Examples of auxiliary components might include, but are not limited to a metal screen, cap, polymeric mouthpiece, or cleaning tools. Therefore, auxiliary component require removal prior to thermal desorption (see step 21 in FIG. 3) and are not limiting to the current invention. Alternatively, non-functional components may attach to pipe body 10. Non-functional components may include, but are not limited to coatings, labels, graphics, or logos that have negligible utility for using pipe body 10 as a smoking device. Non-functional components might burn away or become damaged during thermal desorption and are also not limiting of the current invention.

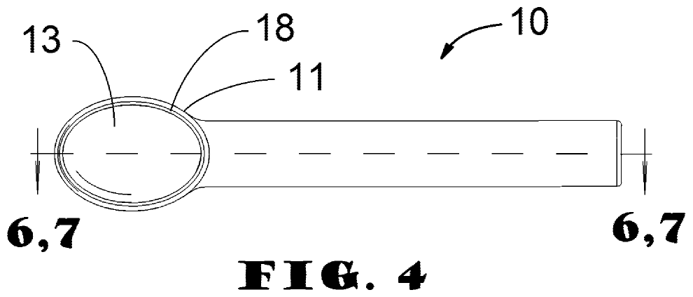

Depicted in FIG. 4 is a plan view of pipe body 10 which makes the non-circular shape of airway 13 in bowl 11 more evident. The elliptical shape of airway 13 in FIG. 4 is not limiting to the current invention. Alternative embodiments may include, but are not limited to shapes that are substantially rectangular, trapezoidal, or triangular. A non-circular bowl has the advantage of being more portable. A narrower profile is more comfortable when stowed in a clothing pocket or bag. A narrower profile also facilitates insertion and removal of pipe body 10 from pockets or bags. Non-circular bowls also allow for more flexibility in terms of ornamental designs.

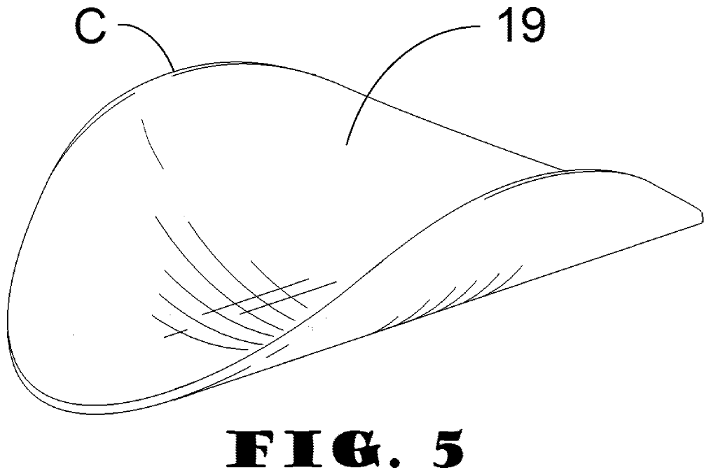

In prior art, non-circular bowl airways are avoided for pipes designed to work in conjunction with a replaceable screen. Commercially available screens are typically available as flat discs. Some screens are flat, others are concave. In both cases, the edge of screens, along its circumference, is initially circular and flat. In principal, providing non-standard screen shapes bespoke to a given non-circular bowl airway shape is possible, but is inconvenient and impractical. A disc-shaped screen could be made to fit a non-circular bowl airway by bending, and plastically deforming the screen so that the majority of the screen's edge contacts the bowl airway. FIG. 5 depicts an example of a reshaped screen 19 that is bent in a way to fit a non-circular airway. Screen 19 is bent to a shape that approximates a saddle in FIG. 5. The screen shape may differ depending on the shape of the bowl airway and is not limiting to the current invention. Attaining the correct shape is important in order to avoid gaps between screen 19 along circumference C, and airway 13 so that materials, other than smoke, are not pulled through the pipe in an undesirable way. Correct shaping of screen 19 without the aid of a tool is difficult. This situation is equivalently problematic if the smoking pipe is designed to accept screen 19 at an angular, non-concentric orientation inside airway 13 of bowl 11. In the case of an angled screen, screen 19 would require reshaping even if airway 13 is otherwise circular. The need for correctly shaping screen 19, in combination with more complicated bowl airway 13 geometries, muddles screen installation thereby making errors likely.

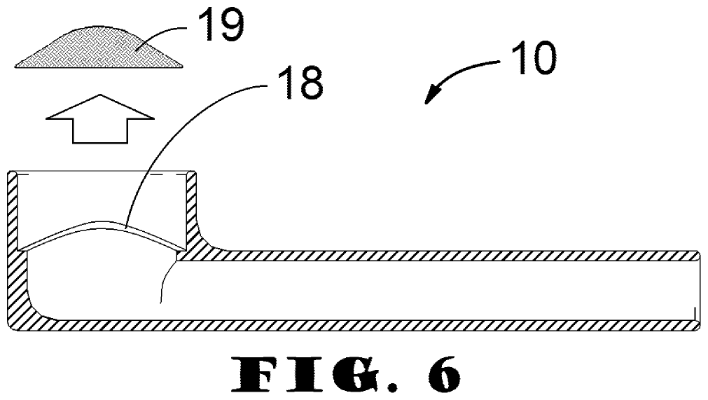

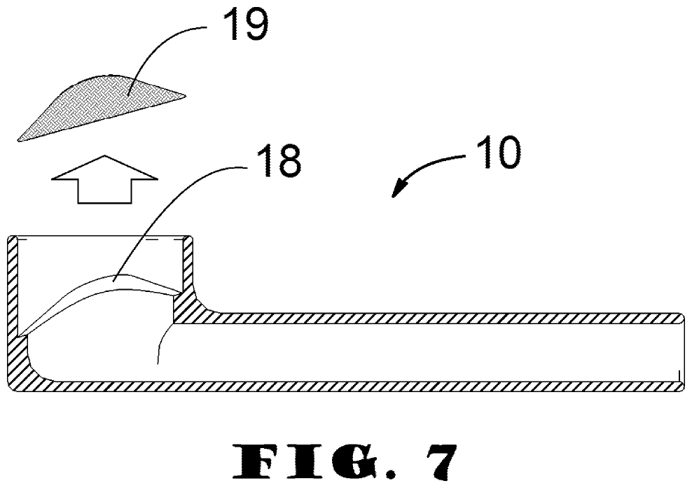

An improvement of the current invention is to use ridge 18, see FIG. 4. The non-circular shape of ridge 18 is better evident in the sectional view of FIG. 6. Also shown in FIG. 6 is screen 19. The arrow indicates that the screen is being removed from the bowl. The screen is depicted as being saddle-shaped during removal in FIG. 6 and FIG. 7. Prior to insertion into airway 13 the circumference C of screen 19 is substantially circular. The non-circular circumference C of screen 19 in FIG. 6 and FIG. 7 indicates that screen 19 has been plastically deformed after having been first pushed into contact with ridge 18 during insertion. Ridge 18 is depicted as continuous protrusion in FIG. 6 and FIG. 7. Alternatively, ridge 18 may have interruptions, or gaps, so that the circumference C of screen 19 contacts ridge 18 intermittently when screen 19 is installed. An uninterrupted ridge 18 is not limiting to the current invention provided that edge 18 substantially reshapes screen 19 as it is pushed into contact with edge 18. In addition to shaping screen 19 appropriately to the shape of airway 13, edge 18 also provides a tactile, as well as a visible boundary that the installer may use to verify proper screen installation. In this way the screen will come to rest at the intended depth, orientation, and with the intended shape within bowl 11 so that there is no appreciable gap between circumference C and airway 13.

In another embodiment, the orientation of screen 19 is also tilted, see FIG. 7. In this case, edge 18 orientates the screen so that it is tilted downwards towards the front of the pipe. The orientation shown in FIG. 7 has the advantage that the right side of screen 19 in FIG. 7 is more reachable for replacement. Moreover, the tilt of screen 19 in FIG. 7 more fully utilizes the volume within bowl 11 for combustible material. However, edge 18 may assume other orientations and the frontward tilt shown in FIG. 7 is not limiting to the current invention. Thus, edge 18 further simplifies screen installation for pipes that are designed to orientate the screen in a complicated, or potentially unintuitive way.

What is claimed is:

1. A smoking pipe comprising:
a bowl integrally formed in the first end of the pipe,
and a stem extending from the bowl to the second end of the pipe, defining an air passage there between.

2. The bowl and stem of claim 1 is further defined as being composed of a single, continuously formed piece of fine ceramic.

3. Said air passage of claim 1 is comprised of a single wall of fine ceramic in claim 2.

4. Said fine ceramic in claim 2 is further defined as being able to withstand sustained temperatures in excess of 3000° F.

5. A smoking pipe comprising:
a bowl integrally formed in the first end of the pipe,
a stem extending from the bowl to the second end of the pipe, defining an air passage there between, and a receiving area, located within the bowl, that accepts a ductile screen.

6. Said screen in claim 5 is further defined as having a circular, substantially flat circumference along it's outer edge.

7. Said receiving area of claim 5 is further defined as having a protruding ridge, or a segmented protruding ridge, that follow a closed, non-circular path.

8. Said protruding ridge of claim 7 is further defined as contacting the circumference of the screen of claim 7 as the screen is pushed into the receiving area.

9. Said screen in claim 6 is further defined as becoming plastically deformed as it is pushed into contact with the protruding ridge in claim 8.

10. The non-circular shape of the protruding ridge in claim 8 is further defined as deforming the screen so that the screen's circumference significantly contacts the air passage of the bowl in claim 5.
